(19) United States
(12) Patent Application Publication
(10) Pub. No.: US 2025/0022166 A1
(43) Pub. Date: Jan. 16, 2025

(54) INFORMATION PROCESSING APPARATUS, CONTROL METHOD, AND STORAGE MEDIUM

(71) Applicant: CANON KABUSHIKI KAISHA, Tokyo (JP)

(72) Inventors: SHOZO YOSHIMURA, Kanagawa (JP); MASAKAZU FUJIKI, Kanagawa (JP); KAZUHIKO KOBAYASHI, Kanagawa (JP); MAKOTO TOMIOKA, Kanagawa (JP)

(21) Appl. No.: 18/769,500

(22) Filed: Jul. 11, 2024

(30) Foreign Application Priority Data
Jul. 13, 2023 (JP) 2023-115170

(51) Int. Cl. G06T 7/73

(52) U.S. Cl. CPC G06T 7/73

(57) ABSTRACT

An information processing apparatus configured to perform position and orientation measurement by using sensor data from a sensor is provided, comprising a first characteristic acquisition unit configured to acquire object variation characteristics that indicate characteristics that influence the accuracy of the position and orientation measurement for each object within the measurement range of the sensor, a proximity object determination unit configured to determine a proximity object that interferes with an object from which the object variation characteristics have been acquired, a second characteristic acquisition unit configured to acquire object variation factor characteristics that indicate characteristics that influence the accuracy of the position and orientation measurement by interfering with other objects with respect to each of the proximity objects, and a position and orientation measurement control unit configured to control the position and orientation measurement processing so as to restrict the use of information in which variation is estimated among the information of objects within the measurement range of the sensor, based on the object variation characteristics and the object variation factor characteristics.

### BACKGROUND OF THE INVENTION

### Field of the Invention

The present invention relates to an information processing apparatus, a control method, and a storage medium.

### Description of the Related Art

At present, there is a technology of an autonomous driving robot (hereinafter referred to as a “movable apparatus”) that autonomously moves and performs tasks in various places such as office buildings, residences, and logistics centers. Such a movable apparatus calculates feature points from captured images, thereby determining space as a map comprised of point cloud data, collections of feature points, and the like, and autonomously moves by comparing the map with the surrounding environment of the movable apparatus.

Japanese Patent Application Laid-Open No. 2022-17612 discloses an invention that calculates the apparent change amount of objects from images captured by a vehicle-mounted camera of an automobile, recognizes objects with a low risk of collision based on the change amount, and excludes these objects from the captured images, thereby reducing the load on collision avoidance processing.

However, Japanese Patent Application Laid-Open No. 2022-17612 sometimes failed to recognize objects having changing features. As a result, objects having changing features caused a reduction in the accuracy of position and orientation measurement.

### SUMMARY OF THE INVENTION

An information processing apparatus of an embodiment of the present invention is configured to perform position and orientation measurement by using sensor data from a sensor, the information processing apparatus comprising at least one processor or circuit configured to function as a first characteristic acquisition unit configured to acquire object variation characteristics that indicate characteristics that influence the accuracy of the position and orientation measurement for each object within the measurement range of the sensor; a proximity object determination unit configured to determine a proximity object that interferes with an object from which the object variation characteristics have been acquired; a second characteristic acquisition unit configured to acquire object variation factor characteristics that indicate characteristics that influence accuracy of the position and orientation measurement by interfering with other objects with respect to each of the proximity objects; and a position and orientation measurement control unit configured to control the position and orientation measurement so as to restrict the use of information in which variation is estimated among the information of objects within the measurement range of the sensor, based on the object variation characteristics and the object variation factor characteristics.

Further features of the present invention will become apparent from the following description of embodiments with reference to the attached drawings.

### BRIEF DESCRIPTION OF THE DRAWINGS

FIG. 1 is a diagram showing a usage scenario example of a first embodiment of the present invention.

FIG. 2 is a diagram showing a configuration example of a movable apparatus system that is provided with an information processing apparatus according to the first embodiment of the present invention.

FIG. 3 is a diagram showing a hardware configuration example of an information processing apparatus according to the first embodiment of the present invention.

FIG. 4 is a flowchart showing an example of the flow of processing of a movable apparatus system that is provided with an information processing apparatus according to the first embodiment of the present invention.

FIG. 5 is an explanation diagram showing an example of the GUI of movable apparatus system that is provided with an information processing apparatus according to the first embodiment of the present invention.

FIG. 6 is a diagram showing a configuration example of a movable apparatus system that is provided with an information processing apparatus according to a modification example of the first embodiment of the present invention.

FIG. 7 is a flowchart showing an example of the flow of details of variation degree acquisition of an information processing apparatus according to a modification example of the first embodiment of the present invention.

FIG. 8 is a flowchart showing an example of the flow of details of variation factor degree acquisition of an information processing apparatus according to a modification example of the first embodiment of the present invention.

FIG. 9 is a diagram showing a configuration example of movable apparatus system that is provided with an information processing apparatus according to a second embodiment of the present invention.

FIG. 10 is a flowchart showing an example of the flow of processing of a movable apparatus system that is provided with an information processing apparatus according to the second embodiment of the present invention.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

First, a first embodiment of the present invention will be explained. The first embodiment relates to the autonomous control of a movable apparatus. Autonomous control of the movable apparatus calculates the position and orientation of the movable apparatus from sensors mounted on the movable apparatus, and controls the movable apparatus so as to follow a plurality of waypoints.

In the present embodiment, the position and orientation of the movable apparatus are measured by using Visual SLAM, which calculates the position and orientation by matching image information captured by an image capturing apparatus mounted on the movable apparatus as a sensor with two-dimensional or three-dimensional map information.

SLAM is an abbreviation for Simultaneous Localization and Mapping. In the Visual SLAM of the present embodiment, feature points are extracted from captured images, and the position and orientation measurements of the image capturing apparatus are performed through feature point matching.

However, the object variation degree (the definition of terms is to be described below) does not solely depend on the type information of the target object, but varies according to the positional relationship between the target object and other proximity objects. Accordingly, in the present embodiment, the likelihood of movement, rotation, or change of appearance of the target object itself, as well as the likelihood of movement, rotation, or change of appearance of an object in close proximity to the target object, are evaluated. That is, object variation characteristics include at least one piece of information that represents the presence or absence of functions that cause an object to move, rotate, or change appearance, or the degree of possibility of an object causing another object to move, rotate, or change appearance.

Based on the results of the two evaluations, the possibility that movement, rotation, or change in appearance occurs in the target object is evaluated. In a case in which this evaluation is higher than a predetermined threshold, position and orientation measurement accuracy is improved by not using features on the target object among an image feature group for position and orientation measurement in position and orientation measurement processing.

In the present embodiment, characteristics that influence the accuracy of position and orientation measurement of SLAM due to movement, rotation, or change in appearance of an object are called object variation characteristics, and the degree of the influence thereof is called the object variation degree. It is assumed that the greater the object variation degree, the greater the influence on the position and orientation measurement accuracy of SLAM.

In addition, characteristics that influence the accuracy of position and orientation measurement in SLAM due to one object interfering with another object, thereby causing movement, rotation, or change in appearance in the other object, are called object variation factor characteristics, and the degree of the influence thereof is called the object variation factor degree.

The greater the object variation factor degree, the greater the influence on the accuracy of position and orientation measurement of SLAM. In the present embodiment, an object from which the object variation characteristics are determined is called a target object, and an object from which the object variation factor characteristics are determined is called a proximity object. That is, the object variation factor characteristics include at least one piece of information that represents either the presence or absence of functions that cause another object to move, rotate, or change appearance, or the degree of possibility of an object causing another object to move, rotate, or change appearance.

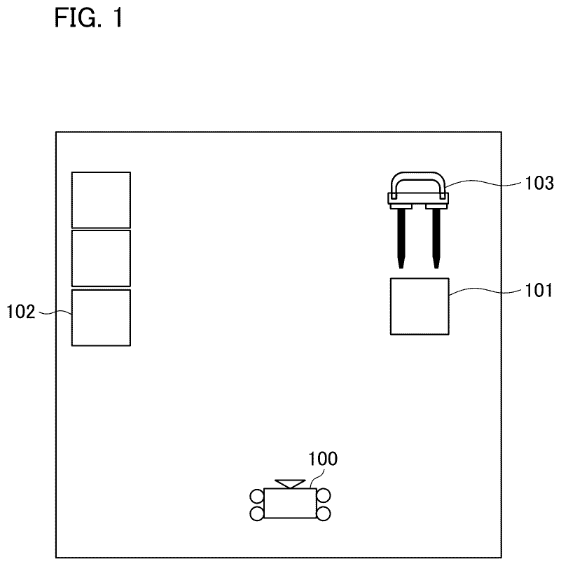

FIG. 1 is a top view of a usage scenario example for a movable apparatus system provided with an information processing apparatus in the present embodiment. Reference numeral 100 denotes the movable apparatus. The information processing apparatus of the present embodiment is disposed in the movable apparatus 100.

The information processing apparatus of the present embodiment performs the measurement of the position and orientation of the movable apparatus 100 by using images captured by an image capturing apparatus disposed in the movable apparatus 100.

Reference numeral 101 denotes an object that influences the accuracy of position and orientation measurement of the movable apparatus 100 by moving. In addition, 102 is the same object as the object 101. Reference numeral 103 denotes a conveyance apparatus capable of moving the object 101.

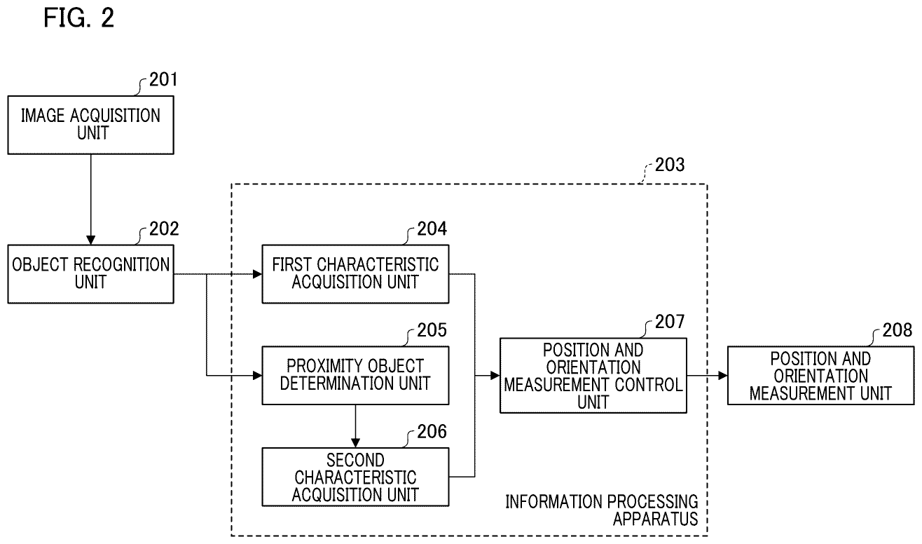

FIG. 2 is a diagram showing a functional configuration of a movable apparatus system that is provided with an information processing apparatus according to the present embodiment. Reference numeral 203 denotes the information processing apparatus according to the present embodiment. The information processing apparatus 203 includes a first characteristic acquisition unit 204, a proximity object determination unit 205, a second characteristic acquisition unit 206, and a position and orientation measurement control unit 207.

The movable apparatus system according to the present embodiment includes an image acquisition unit 201, an object recognition unit 202, an information processing apparatus 203, and a position and orientation measurement unit 208.

In the present embodiment, the image acquisition unit 201 is an image capturing apparatus disposed on the movable apparatus 100. The object recognition unit 202 recognizes the object type information of a target object included within the captured image acquired by the image acquisition unit 201, as well as pixel region information that is occupied by the target object in the captured image.

In the present embodiment, a word representing an object name is used as object type information. The image acquisition unit 201 is an example of a sensor. An image captured by the image acquisition unit 201 is an example of sensor data detected by the sensor. The object recognition unit 202 recognizes an object from the sensor data.

The first characteristic acquisition unit 204 acquires object variation characteristics based on the object type information of the target object that has been input from the object recognition unit 202. In the present embodiment, the first characteristic acquisition unit 204 acquires an object variation degree, which is the degree of the object variation characteristics. That is, the first characteristic acquisition unit 204 acquires object variation characteristics that indicate the characteristics that influence the accuracy of position and orientation measurement for each object within the measurement range of the sensor.

The proximity object determination unit 205 determines proximity objects that are near to or interfere with the object for which characteristics have been acquired by the first characteristic acquisition unit 204, based on the object type information and the pixel region information of the object that has been input from the object recognition unit 202.

The second characteristic acquisition unit 206 acquires object variation factor characteristics based on the object type information of the proximity objects determined by the proximity object determination unit 205. In the present embodiment, the second characteristic acquisition unit 206 acquires an object variation factor degree, which is the degree of the object variation factor characteristics. That is, the second characteristic acquisition unit 206 acquires object variation factor characteristics that indicate characteristics that influence the accuracy of position and orientation measurements due to interference by each proximity object with other objects.

The position and orientation measurement control unit 207 determines the control content of position and orientation measurement processing based on the object variation characteristics acquired by the first characteristic acquisition unit 204, the pixel region information that the target object occupies within the image, and the object variation factor characteristics acquired by the second characteristic acquisition unit 206. That is, the position and orientation measurement control unit 207 controls the position and orientation measurement so as to restrict the use of information, among the information of objects within the measurement range of the sensor, in which variation is estimated, based on the object variation characteristics and object variation factor characteristics.

The position and orientation measurement unit 108 performs position and orientation measurements based on the control content determined by the position and orientation measurement control unit 207.

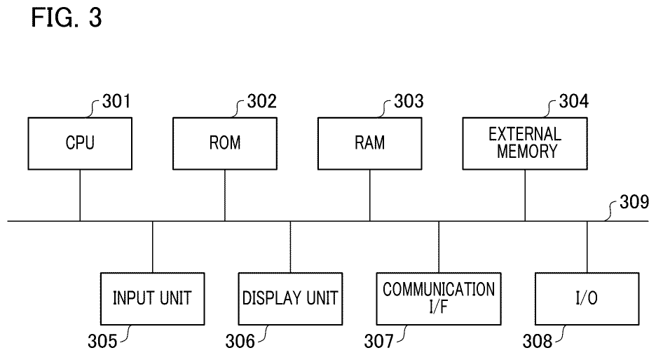

FIG. 3 is a diagram showing a hardware configuration of the information processing apparatus 203. Reference numeral 301 denotes a CPU, and the processing of the present embodiment is implemented by the CPU 301 executing a program that describes the operations in the present embodiment. CPU is an abbreviation for Central Processing Unit. In addition, the CPU 301 performs control of various devices that are connected to a system bus 309.

Reference numeral 302 denotes a ROM, and the ROM stores a program for a BIOS and a boot program. ROM is an abbreviation for Read Only Memory. BIOS is an abbreviation for Basic Input/Output System.

Reference numeral 303 denotes a RAM, and is used as the primary storage apparatus for the CPU 301. RAM is an abbreviation for Random-Access Memory. Reference numeral 304 denotes an external memory, and the external memory stores the program that is processed by the information processing apparatus 203.

An input unit 305 is a keyboard, a mouse, and the like, and performs processing relating to the input of information and the like. A display unit 306 outputs the calculation results of the information processing apparatus 203 to a display apparatus according to a command from the CPU 301. It should be noted that the display apparatus is a liquid crystal display apparatus, a projector, an LED indicator, or the like, and the type of display apparatus does not matter.

Reference numeral 307 denotes a communication I/F. I/F is an abbreviation for interface. The first characteristic acquisition unit 204, the proximity object determination unit 205, and the position and orientation measurement control unit 207 perform input of object type information, and output of control content via the system bus 309.

The communication I/F 307 performs information communication via a network. A communication interface that corresponds to the communication I/F 307 may be any type of communication interface, such as Ethernet, USB, serial communication, or wireless communication. USB is an abbreviation for Universal Serial Bus. Reference numeral 308 denotes an I/O. I/O is an abbreviation for Input/Output.

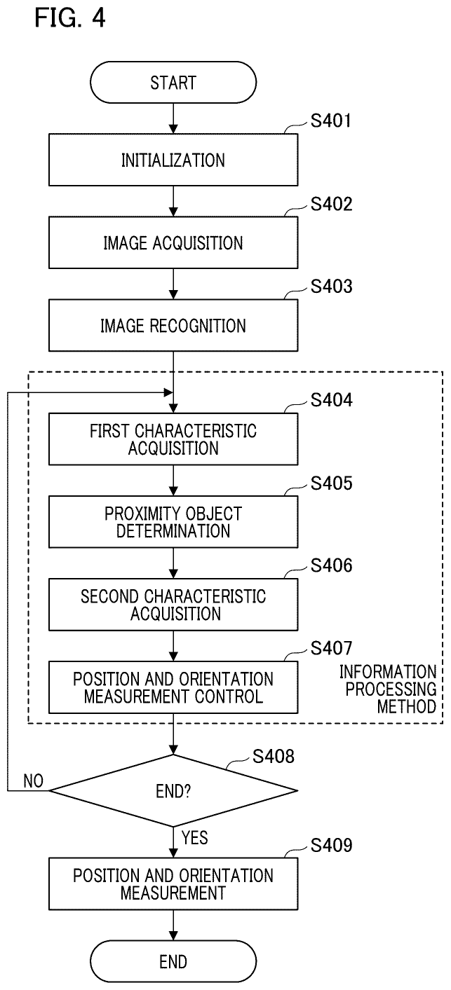

FIG. 4 is a flowchart explaining the processing of a movable apparatus system provided with the information processing apparatus 203. At step S401, the information processing apparatus 203 performs initialization processing. That is, the CPU 301 reads and executes a program from the external memory 304, and the information processing apparatus 203 is made operable.

During initialization processing, for example, tables that store object type information, object variation characteristics, and object variation factor characteristics, which are acquired and used by each configuration, as well as control content and the like determined by the position and orientation measurement control unit 207, are loaded into the RAM 303.

In the present embodiment, it is assumed that a user inputs information of each table with respect to objects in the environment in which the movable apparatus operates by using an input device (not shown). Here, the data format of each table in the present embodiment will be explained.

At step S404, the first characteristic acquisition unit 204 references the object variation characteristics table. The object variation characteristics table can uniquely determine the object variation degree of each object based on the object type information of each object.

In the present embodiment, with respect to an object that has a moving function, TRUE is held in the table as the object variation degree associated with the object type information of that object. In contrast, with respect to an object that does not have a moving function, FALSE is held in the table as the object variation degree associated with the object type information of that object.

At step S406, the second characteristic acquisition unit 206 references an object variation factor characteristics table. The object variation factor characteristics table can uniquely determine the object variation factor degree for each object based on the object type information of that object.

In the present embodiment, with respect to an object that has a function to cause movement, TRUE is held in the table as the object variation factor degree associated with the object type information of that object. In contrast, with respect to an object that does not have a function to cause movement, FALSE is held in the table as the object variation factor degree associated with the object type information of that object.

After the series of initialization processes is completed, at step S402, the image acquisition unit 201 acquires image data from the image capturing apparatus. At step S403, the object recognition unit 202 recognizes target objects and proximity objects that are included in the image acquired by the image acquisition unit 201.

A method for recognizing objects in an image and the pixel region information of objects in an image can be applied as described in Reference 1 (REDMON et al., “You Only Look Once: Unified, Real-Time Object Detection”, CVPR 2016).

At step S404, the first characteristic acquisition unit 204 acquires object variation characteristics based on the object type information. Specifically, the first characteristic acquisition unit 204 designates as a target object one of the plurality of objects recognized at step S403, for which the control content of position and orientation measurement has not yet been determined.

Then, the first characteristic acquisition unit 204 acquires the object variation degree of the target object by searching the object variation characteristics table using the object type information of the target object as a key.

At step S405, the proximity object determination unit 205 determines proximity objects that are near the object for which the first characteristic acquisition unit 204 acquired the object variation degree, and acquires the object type information of these determined proximity objects. In the present embodiment, the proximity object determination unit 205 calculates the region centroid of each object recognized by the object recognition unit 202 from the region information of a plurality of objects. Then, the proximity object determination unit 205 determines the object with the smallest centroid distance from the target object as the proximity object.

At step S406, the second characteristic acquisition unit 206 acquires object variation factor characteristics based on the object type information of the proximity object. In the present embodiment, the object variation factor degree of the proximity object is acquired by searching the object variation factor characteristics table using the object type information of the proximity object as a key.

At step S407, the position and orientation measurement control unit 207 determines the control content of the position and orientation measurement unit 208 based on the object variation degree and the object variation factor degree. In the present embodiment, the position and orientation measurement control unit 207 calculates the logical sum of the object variation degree and the object variation factor degree and, based on the calculation result, determines the application of the control content loaded at step S401.

Specifically, in a case in which the calculation result is TRUE, the position and orientation measurement control unit 207 does not use the features within the image region of the target object for position and orientation measurement as the control content. Furthermore, in a case in which the calculation result is FALSE, the position and orientation measurement control unit 207 uses the features within the image region of the target object for position and orientation measurement without performing control.

The operations executed by the position and orientation measurement control unit 207 on the object variation degree and the object variation factor degree may be a logical AND operation or arithmetic operation.

At step S408, the information processing apparatus 203 performs a decision as to whether or not to terminate the processing. In the Present Embodiment, the information processing apparatus 203 decides to terminate the processing (Yes in step S408) in a case in which the control content has been determined for all objects recognized at step S403, and decides not to terminate the processing otherwise (No in step S408).

In a case in which the information processing apparatus 203 has decided to terminate the processing, the processing of step S409 is executed. In a case in which the information processing apparatus 203 has decided not to terminate the processing, the processing of step S404 is executed.

At step S409, the position and orientation measurement unit 208 measures the position and orientation of the image capturing apparatus based on the control content that has been determined at step S407.

In the first embodiment explained above, control is performed so that features within the pixel regions of objects with a high object variation degree are excluded from the target of position and orientation measurement processing, based on the object variation characteristics of the target object and the object variation factor characteristics of proximity objects. Thus, in the first embodiment, it is possible to improve the accuracy of position and orientation measurement.

### Modification Example 1-1

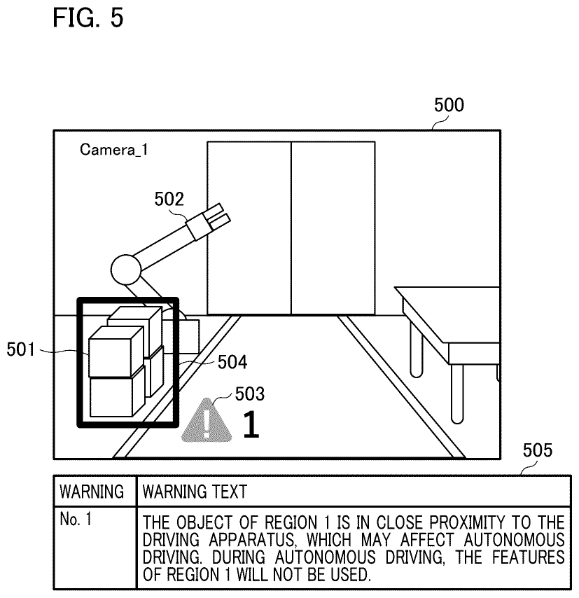

It should be noted that it may be made possible for a user to verify the control content of the position and orientation measurement control unit 207 in the first embodiment by using a GUI. FIG. 5 shows an example in which the control content of the position and orientation measurement unit 208 is output to a display screen.

Reference numeral 500 indicates a captured image captured by an image capturing apparatus disposed on the movable apparatus 100, which was acquired by the image acquisition unit 201. Reference numeral 501 denotes a target object that influences the measurement accuracy of the position and orientation measurement unit 208 due to movement or changes in appearance. Reference numeral 502 denotes a driving apparatus that is in proximity to the target object 501 and has a function of moving the target object 501.

Reference numeral 503 denotes a warning mark superimposed on the captured image, based on the control content of the position and orientation measurement control unit 207. Reference numeral 504 denotes the pixel region occupied by the target object 501 in the captured image. Reference numeral 505 denotes a display field that displays the control content of the position and orientation measurement control unit 207 in textual form.

In the display of the display field 505, it is indicated that, because the object (the target object 501) of region 1 (the pixel region 504) may be moved by the driving apparatus (the driving apparatus 502), the features of region 1 are not used for position and orientation measurement.

As described above, through the GUI shown in FIG. 5, a user is able to visually verify the control content of the position and orientation measurement control unit 207.

### Modification Example 1-2

In the first embodiment, the “presence or absence of a moving function” was made the object variation degree. However, the object variation degree is not limited to the presence or absence of a moving function, and can be any variation characteristic of the target object that influences the accuracy of position and orientation measurement.

For example, the object variation degree may be determined based on the presence or absence of an opening and closing function, such as a door or a hinge, instead of a moving function. In addition, the object variation degree may be determined based on the presence or absence of a rotary mechanism, such as a bearing. This enables a more accurate evaluation of the object variation degree, which in turn improves the accuracy of position and orientation measurement.

In addition, the present invention may determine the object variation degree not by the “presence or absence” of a moving “function” but by the “degree” of a moving “function.” For example, because the object becomes easier to move as the friction coefficient decreases, it may be determined that the object variation degree is large.

Furthermore, as described above, the degree of function is not limited to the “moving function.” Here, a method of controlling position and orientation measurement based on the degree of function is explained. It should be noted that only the differences from the first embodiment will be explained.

At step S401, the information processing apparatus 203 loads a table from which the object variation degree can be uniquely determined from the object type information of the target object. In this context, the object variation degree serves as the slide friction coefficient. In addition, the information processing apparatus 203 also loads the expressions and thresholds to be used in step S407. The expressions and thresholds will be described below.

At step S404, the first characteristic acquisition unit 204 acquires the slide friction coefficient as the object variation degree from the object type information of the target object. In this context, the object variation degree is acquired by referring to the table loaded at step S401.

At step S407, the position and orientation measurement control unit 207 determines the control content based on the object variation degree acquired at step S404 and the object variation factor degree acquired at step S406. In this context, in a case in which a proximity object has a function to move the target object, the object variation factor degree is acquired as “1”. In addition, in a case in which a proximity object does not have a function to move the target object, the object variation factor degree is acquired as “0”. The position and orientation measurement control unit 207 determines the control content according to Expression (1).

$$1 / ω \times f ) th \qquad ( Expression 1 )$$

In Expression (1), ω represents the object variation degree, that is, the slide friction coefficient. f represents the object variation factor degree. th is the threshold value that was set in advance and loaded at step S401.

In a state in which Expression (1) is satisfied, the position and orientation measurement control unit 207 uses the features included in the image region of the target object in position and orientation measurement processing. That is, the position and orientation measurement control unit 207 uses the features that are included in the image region of the target object in position and orientation measurement processing only in a case in which the target object has a slide friction coefficient below a certain level and the proximity object has a move function.

In Expression (1), although the control content was determined by the threshold value th, the variable values of the control content may be determined from the left-hand side value of Expression (1). For example, the greater the left-hand side value of Expression (1), the smaller the weight that may be assigned to the features included in the pixel region of the target object in position and orientation measurement processing.

As described above, according to the present modification example, by evaluating the object variation degree by the degree thereof, it becomes possible to more precisely evaluate the object variation degree, and the accuracy of position and orientation measurement can be further improved.

In addition, the object variation factor degree is similarly not limited to the “presence or absence of a function to cause movement.” The object variation factor degree can be any property of a proximity object that influences the accuracy of position and orientation measurement by changing the position, orientation, or appearance of surrounding objects.

The object variation factor degree can be, for example, a property that causes movement, such as that of a cart, or a property that changes appearance, such as paint and brushes. This enables a more accurate evaluation of the variation factor degree, and consequently, can further improve the accuracy of position and orientation measurement.

Furthermore, the object variation factor degree need not be limited solely to the “presence or absence of a function” and may also be determined by the “degree of a function.” In this case, the greater the product of the object variation degree and the object variation factor degree of a feature, the smaller the weight that may be assigned to the features included in the image region of the target object in position and orientation measurement processing. Thus, by evaluating the object variation factor degree in terms of degree, it becomes possible to more precisely evaluate the object variation factor degree, and the accuracy of position and orientation measurement can be further improved.

### Modification Example 1-3

In the First Embodiment, although the position and orientation measurement control unit 207 determined the control content with respect to the usability of features, any control that improves the accuracy of position and orientation measurement is sufficient. For example, a priority may be set for the use of features in position and orientation measurement according to calculation results.

In this context, features of a target object having a small object variation degree are assigned a high priority in position and orientation measurement processing. Accordingly, even in a case in which there is a limitation on the number of features used in position and orientation measurement processing, the accuracy of position and orientation measurements can be ensured.

### Modification Example 1-4

In the First Embodiment, the object variation degree and the object variation factor degree were evaluated by the logical sum in step S407. However, other calculation methods may be used provided that the unit can determine control that improves position and orientation measurement accuracy.

For example, a calculation may be performed by the logical product of the object variation degree and the object variation factor degree, without reducing the features used. Alternatively, the object variation degree and the object variation factor degree may be calculated by arithmetic operations, and weighting of the features may be performed.

Accordingly, it is possible to improve the accuracy of position and orientation measurement in various usage scenarios.

### Modification Example 1-5

The present invention may perform control according to the calculation results in step S407 with respect to the processing of storing the features in the map information. For example, features included in the pixel region of a target object for which the calculation result is FALSE may not be stored in the map information.

As described above, if the object variation degree and the object variation factor degree are expressed in degrees, features within the image region of the target object may not be stored in the map information in a case in which the product of the object variation degree and the object variation factor degree is less than a predetermined threshold.

Accordingly, it is possible to prevent features on objects having a high object variation degree from being stored in the map information, and to prevent a decrease in position and orientation measurement accuracy.

### Modification Example 1-6

In the First Embodiment, at step S405, the object having the centroid position closest to the target object in the captured image was determined to be the proximity object. However, in the present invention, proximity objects need not be limited to one.

For example, in the region information of each object within the captured image, objects in the region for which the centroid distance to the target object is less than or equal to a threshold value are selected as a proximity object group. Thereafter, if any one of the plurality of proximity objects has a function to cause movement, the object variation factor degree of the proximity object group that is configured by the plurality of proximity objects may be set to “Has move function”.

Alternatively, with respect to the object variation factor degree of a proximity object or objects included in a proximity object group, the object variation factor degree may be evaluated so that the greater the distance from the target object, the smaller the object variation factor degree.

According to the present modification example, by performing the evaluation of various object variation factor degrees in this way, the accuracy of the evaluation can be improved.

### Modification Example 1-7

In the explanation described above, the position and orientation control unit 207 had uniformly determined the use/non-use, priority, or weight of a feature group of within the pixel region occupied by the target object in the image in position and orientation measurement processing. However, the present invention may take into account the shape, and the position and orientation of the target object or a proximity object, and determine the use/non-use, priority, or weight in the position and orientation measurement processing according to the position of features.

Here, the processing content will be explained. At step S401, the information processing apparatus 203 reads a table of a kind that enables unique determination of an address to three-dimensional model data of a target object held in a holding unit (not shown), based on the object type information of the target object.

In addition, the information processing apparatus 203 also reads from a table that enables reference to information on the movement, rotation, and changes in appearance that may occur in the target object, based on the object type information of the target object. In the present modification example, it is assumed that information such as movement in the horizontal direction and rotation about the vertical axis center is held for each target object.

At step S407, the position and orientation measurement control unit 207 performs calculations based on the object variation degree acquired at step S404 and the object variation factor degree acquired at step S406, and references the three-dimensional model with respect to the target object according to the calculation results. In the present modification example, the three-dimensional model is referenced in a case in which the logical sum of the object variation degree and the object variation factor degree is TRUE.

The position and orientation measurement control unit 207 measures the relative position and orientation of the target object and the image capturing apparatus by performing matching processing on the captured image and the three-dimensional model of the target object. Thereafter, based on changes in the object such as movement, rotation, and appearance that may occur, the relative position and orientation of the object and the image capturing apparatus after these changes are calculated, and the three-dimensional model after the changes is superimposed on the captured image.

Based on the superimposition results, the position and orientation measurement control unit 207 selects feature points within the pixel region occupied by the target object in the captured image that can be measured consistently before and after changes of the target object. In the present modification example, it is assumed that features that cannot be measured after the changes are not used.

Alternatively, a probability distribution may be included in the information of possible movements, rotations, and changes in appearance, and weighting may be applied so that features that cannot be measured in a case in which changes of low probability occur are not used for position and orientation measurement.

Thus, according to the present modification example, by selecting features within the pixel region by using a three-dimensional model, it is possible to exclude only the minimum necessary features and improve the accuracy of position and orientation measurement.

### Modification Example 1-8

In the First Embodiment, the position and orientation control unit 207 determined the control content for position and orientation measurements. However, the control subject may be any control subject that can improve the accuracy of position and orientation measurements. For example, the driving apparatus arranged on the movable apparatus 100 may be controlled so as to prevent the movable apparatus 100 from passing near a target object having a large object variation degree. Alternatively, the orientation of the movable apparatus 100 may be changed so that the target object is not included in the observation range of the sensors for position and orientation measurement.

Accordingly, according to the present modification example, it is possible to more reliably prevent a decrease in position and orientation measurement accuracy.

### Modification Example 1-9

In the First Embodiment, object variation characteristics and object variation factor characteristics were acquired by referencing a table, using object type information as a key. In the present modification example, a method is explained in which object variation characteristics and object variation factor characteristics are estimated by utilizing an object arrangement characteristics database that holds object type information and positional relationships of an object group.

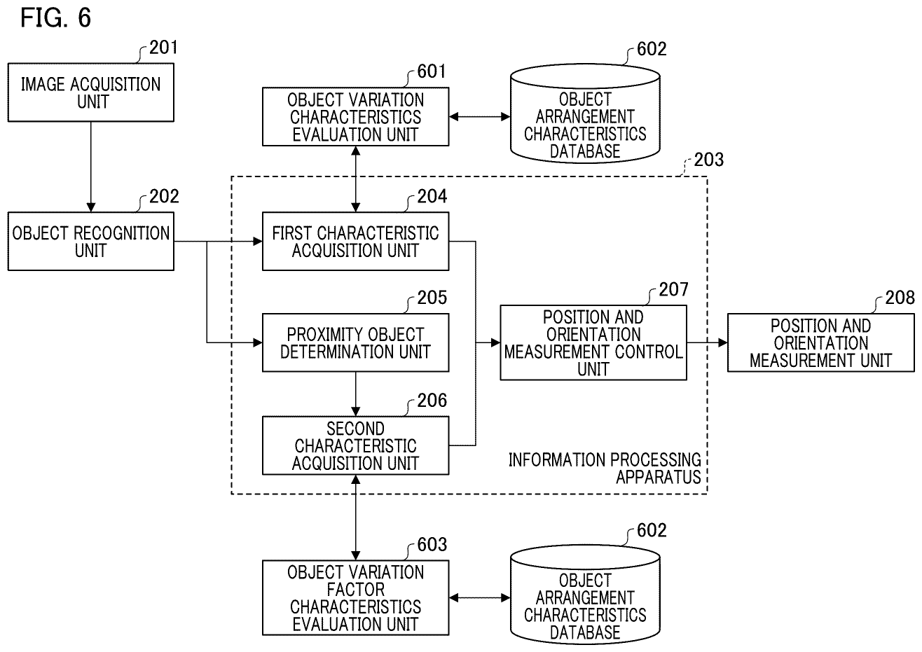

FIG. 6 is a configuration of the information processing apparatus 203 according to the present modification example, and is a block diagram showing a configuration that estimates object variation characteristics and object variation factor characteristics by using an object arrangement characteristics database. In the following explanation of FIG. 6, only the differences from FIG. 2 are explained.

The object recognition unit 202 recognizes object type information with respect to the target object and objects around the target object, and pixel region information that each object occupies within the captured image. The object variation characteristics evaluation unit 601 evaluates object variation characteristics based on the object type information that has been input from the first characteristic acquisition unit 204. An object variation factor characteristics evaluation unit 603 evaluates object variation factor characteristics based on the object type information that was input from the second characteristic acquisition unit 206.

The object arrangement characteristics database 602 is a database configured to hold arrangement characteristics that represent the positional relationships of a plurality of objects. The arrangement characteristics are knowledge data that have generalized the three-dimensional positional relationships of objects in the real world. The object arrangement characteristics database 602 holds the three-dimensional positional relationships of objects in space by associating these positional relationships.

Specifically, the object arrangement characteristics database 602 holds characteristics within the database such as “chairs are commonly found next to desks, but never on top of desks.” In addition, the object arrangement characteristics database 602 holds characteristics within the database with respect to what kind of arrangements and configurations are common (and what arrangements and configurations are not common) in reality.

The object arrangement characteristics database 602 in the present embodiment is a pre-trained neural network that has been trained to infer the characteristics information of the constituent parts of an object from the characteristics information of surrounding objects.

Specifically, this neural network is a pre-trained neural network composed of 24 stacked layers of Transformers, as disclosed in Document 2 (Vaswani, et al., “Attention is All You Need,” Neural IPS 2017).

In addition, in the present example, the input dimensionality and output dimensionality of the Transformer is 512, that is, a configuration is assumed in which a maximum of 512 pieces of object characteristics information are input, and the same number of 512 dimensional outputs can be obtained.

Specifically, the encoder network used in Document 3 (Devlin, et al., “BERT: Pre-training of Deep Bidirectional Transformers for Language Understanding,” arXiv 2018) is employed.

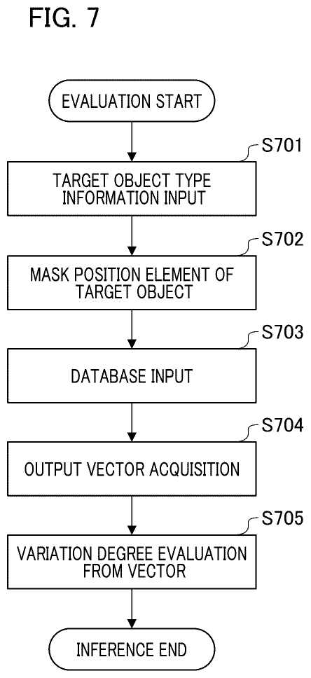

FIG. 7 is a flowchart showing the flow of processing in the object variation characteristics evaluation unit 601 in the present modification example. At step 701, the first characteristic acquisition unit 204 inputs the object type information and position information of the target object and objects around the target object into the object variation characteristics evaluation unit 601, based on the captured image acquired by the image acquisition unit 201.

At step 702, the object variation characteristics evaluation unit 601 generates a feature vector in which the object type information of the target object and the surrounding objects thereof is arranged, and a position vector that represents the positions of these objects. In addition, at step 702, the object variation characteristics evaluation unit 601 masks the position coordinate elements in the generated position vector that correspond to the target object.

Here, to mask the position coordinate elements is to replace those position elements with a mask token (a special label that indicates that the position coordinates are unknown). Here, an object type vector is a one-dimensional column vector, in which object type information is arranged in each element.

At step 703, the object variation characteristics evaluation unit 601 inputs the vector generated and masked in step 702 into the object arrangement characteristics database 602.

At step 704, the object variation characteristics evaluation unit 601 acquires the output vector of the object arrangement characteristics database 602.

At step 705, the object variation characteristics evaluation unit 601 evaluates the object variation characteristics based on the output vector of the object arrangement characteristics database 602. In the present modification example, the object variation characteristics evaluation unit 601 evaluates object variation characteristics based on the likelihood of the inference results with respect to the position and orientation elements of the output vector.

The object variation characteristics evaluation unit 601 evaluates the object variation degree of the target object so that the object variation degree becomes high in a case in which the likelihood of the inference results of the position coordinates of objects other than the target object is low, and becomes low in a case in which the likelihood of the inference results of the position coordinates of objects other than the target object is high.

The level of likelihood is determined by the magnitude thereof relative to the threshold value that was read at step S401. In the present modification example, the object variation characteristics evaluation unit 601 inputs the evaluation results into the first characteristic acquisition unit 204.

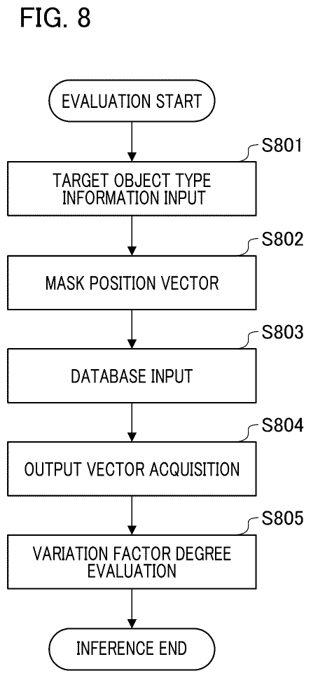

FIG. 8 is a flowchart showing the flow of processing in the object variation factor characteristics evaluation unit 603 in the present modification example. At step 801, the second characteristic acquisition unit 206 inputs object type information of the proximity object and objects surrounding the proximity object into the object variation factor characteristics evaluation unit 603, based on the captured image acquired by the image acquisition unit 201.

At step 802, the object variation factor characteristics evaluation unit 603 generates a position vector in which position coordinate elements are masked, and an object type vector. In the present modification example, the object variation factor characteristics evaluation unit 603 masks the position coordinate elements in all objects.

At step 803, the object variation factor characteristics evaluation unit 603 inputs the vectors generated in step 802 into the object arrangement characteristics database 602.

At step 804, the object variation factor characteristics evaluation unit 603 acquires the output vector of the object arrangement characteristics database 602.

At step 805, the object variation factor characteristics evaluation unit 603 evaluates object variation factor characteristics based on the output vector of the object arrangement characteristics database 602. In the present modification example, the object variation factor characteristics evaluation unit 603 evaluates object variation characteristics based on the likelihood of inference results, with respect to the position and orientation elements of the output vector.

The object variation characteristics evaluation unit 601 evaluates the object variation factor degree of the proximity object so that the object variation factor degree becomes high in a case in which the likelihood of the inference results of the position coordinates of objects other than the proximity object is low, and becomes low in a case in which the likelihood of the inference results of the position coordinates of objects other than the proximity object is high.

The level of likelihood is determined by the magnitude thereof relative to the threshold value that was read at step S401. In the present modification example, the object variation characteristic evaluation unit 603 inputs the evaluation results into the second characteristic acquisition unit 206.

Thus, according to the present modification example, by utilizing the object arrangement characteristics database 602, because it is possible to predict the characteristics of a target object and a proximity object, it is possible to reduce the complexity of setting the object variation degree and object variation factor degree.

In the present modification example, the object variation characteristics evaluation unit 601 and the object variation factor characteristics evaluation unit 603 evaluate the object variation degree and the object variation factor degree by comparing the input vector and the output vector of the object arrangement characteristics database 602.

The evaluation method of the present invention is not limited to a comparison between the input vector and the output vector. For example, a plurality of types of output vectors, which are the predicted results of the object arrangement characteristics database 602, may be obtained, and the greater the number of output vectors obtained, the more likely objects are to move or be moved, and the object variation degree and object variation factor degree may be evaluated as large. Alternatively, the likelihood of these prediction results may be acquired along with the prediction results, and the lower the likelihood, the more likely the object is recognized to move, and the object variation degree may be evaluated as large.

Accordingly, according to the present modification example, it is possible to evaluate the object variation degree and the object variation factor degree with high accuracy even in diverse environments.

In addition, in the present modification example, although the object variation degree was evaluated from a vector generated based on a captured image of the image capturing unit 201, any method may be used if the object variation degree can be evaluated by using a plurality of captured images. For example, the object variation degree of a target object from a certain image may be evaluated by considering the object variation degree evaluated from another image.

Accordingly, according to the present modification example, it is possible to accurately evaluate the object variation degree of a target object without being influenced by specific image capturing environments or objects.

In addition, the proximity object determination unit 205 may use the object arrangement characteristics database 602. For example, based on the object type information that has been input from the object recognition unit 202 and the first characteristic acquisition unit 204, the proximity object determination unit 205 inputs a feature vector, in which object type information other than that of the target object is masked, into the object arrangement characteristics database 602.

Thereafter, the proximity object determination unit 205 can predict objects that are generally in proximity to an object by acquiring the output of the object arrangement characteristics database 602.

Thus, according to the present modification example, by using the object arrangement characteristics database 602, the omission of recognition of proximity objects can be reduced and the position and orientation measurement processing accuracy can be further improved.

In addition, in the position and orientation measurement control unit 207, by using the object arrangement characteristics database 602 with respect to the features within the pixel region occupied by the target object in the image, it may be possible to simulate and select the positions of target objects with high object variation degrees and proximity objects with high object variation factor degrees.

Specifically, the position and orientation measurement control unit 207 inputs feature vectors and position vectors that include both the target object and proximity objects into the object arrangement characteristics database 602. At this time, the position coordinate elements corresponding to the target object and proximity objects are masked.

Thereafter, the position and orientation measurement control unit 207 acquires the output vector from the object arrangement characteristics database 602, and after changing the position coordinates that were masked at the time of input, the position and orientation measurement control unit 207 acquires the positional relationships before and after the change as the positional relationships of the position coordinates in the output vector before the change.

Based on the 3D model read during the initialization processing at step S401 and the positional relationships before and after the change, the simulated results are superimposed on the captured image. The position and orientation measurement control unit 207 executes control content wherein, in a case in which the results of the superimposition become a generally predetermined arrangement, features that remain measurable are used for position and orientation measurement, and in a case in which the results of the superimposition do not become a generally predetermined arrangement, features that become unmeasurable are not used for position and orientation measurement.

Thus, according to the present modification example, by using the object arrangement characteristics database 602 to estimate the positional relationships of a plurality of objects and performing simulations of the features thereof, the accuracy of position and orientation measurement can be improved even in an environment in which a plurality of objects exist.

In the present modification example, although the object variation characteristics evaluation unit 601 evaluates the object variation degree by referencing the object arrangement characteristics database 602, the database need not be limited to object arrangement characteristics. For example, in an environment in which the movable apparatus 100 moves, a holding unit that holds information on object movements may be provided, and the object variation characteristics evaluation unit 601 may evaluate the variation degree by referencing the holding unit.

Here, information that an object has moved may be acquired from sensors (for example, image sensors such as surveillance cameras, and object recognition apparatuses) installed in the environment in which the movable apparatus moves. In addition, information that an object has moved may be the difference of position coordinates in the horizontal two-dimensional coordinate system of the environment in which the object exists. In addition, information that an object has moved may be the difference in coordinates between a certain time and a different time. The certain time and the different time are assumed to be any two arbitrary times.

The holding unit holds object type information in association with the difference in position coordinates, and the object variation characteristics evaluation unit 601 references the holding unit, and in a case in which there is information indicating that the position and orientation of an object have changed, the object variation degree is evaluated as 1, otherwise, the object variation degree is evaluated as 0. Alternatively, with respect to the information regarding movement, the object variation degree may be evaluated by comparing numerical values, such as distance and rotated angle, with a threshold.

In addition, the holding unit may also hold document information. Document information is data that includes text, such as documents and news articles, and is data that has been created for the purpose of being read, viewed, or listened to by humans.

For example, in document information that indicates work processes, attention may be focused on parts that describe the target object and the objects surrounding the target object, and the greater the number of types of arrangements between the target object and the objects surrounding the target object, the more the target object is determined to be used in various workplaces, and the variation degree may be evaluated as large.

Within document information, a method of recognizing positional relationships between objects from the text of the document is disclosed in Document 4 (Benjamin et al., “I2T: Image Parsing to Text Description,” IEEE).

Similar to the object variation characteristics evaluation unit 601, the object variation factor characteristics evaluation unit 603 need not use the object arrangement characteristics database 602. The object variation factor characteristics evaluation unit 603 may use a holding unit configured to hold information regarding objects that have moved other objects. Information about other objects being moved or the distance moved within that information may also be used by the object variation factor characteristics evaluation unit 603.

As described above, by controlling the position and orientation measurement processing based on the actual performance of the variation of the target object and the performance of proximity objects in causing variation in surrounding objects, the present modification example can more reliably improve the accuracy of position and orientation measurement.

### Second Embodiment

Next, a Second Embodiment of the present invention will be explained. In the First Embodiment, a method of controlling position and orientation measurement based on the characteristics of an object and the characteristics of a proximity object that is in proximity to the object, thereby improving accuracy, was explained. In the Second Embodiment, a method of controlling position and orientation measurement based on the characteristics of the region in which the object exists, thereby improving accuracy, will be explained.

In the present embodiment, the characteristics of a region that influence the accuracy of position and orientation measurement of SLAM due to movement, rotation, or change in appearance of an object within the region are called region variation characteristics, and the degree of the influence thereof is called the region variation degree. In the present embodiment, the greater the region variation degree, the lower the weight assigned to the features within the region occupied by the objects that exist within the region on the image in the position and orientation measurement processing, compared to the weight assigned to other features.

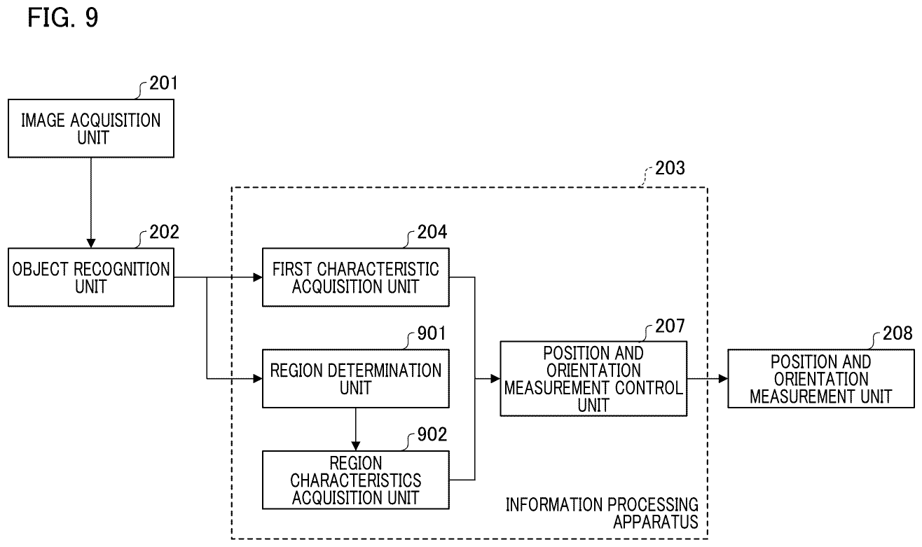

FIG. 9 shows the configuration of the information processing unit 203 according to the Second Embodiment. With respect to FIG. 9, the same reference numerals are assigned to the same configurations as in FIG. 2, which is the configuration diagram of the First Embodiment, and explanations are omitted for configurations that are the same, with explanations limited to the differences from FIG. 2.

A region determination unit 901 determines the region in which the target object exists and outputs the type information of that region to a region characteristics acquisition unit 902.

The region characteristics acquisition unit 902 acquires the region variation characteristics based on the type information of the region that has been input. In the present embodiment, the region characteristics acquisition unit 902 acquires the region variation degree, which is the degree of the region variation characteristics. The region characteristics acquisition unit 902 outputs the acquired region variation degree to the position and orientation measurement unit 207.

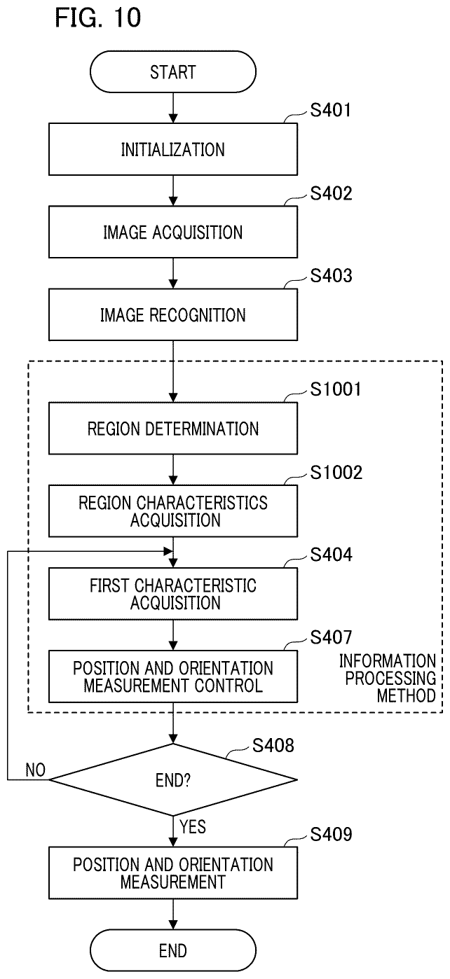

FIG. 10 is a flowchart showing the processing flow of a movable apparatus system provided with the information processing unit 203 according to the Second Embodiment. With respect to FIG. 10, the same reference numerals are assigned to the same configurations as in FIG. 4, which is the flowchart of the First Embodiment, and explanations are omitted for configurations that are the same, with explanations limited to the differences from FIG. 4.

At step S1001, the region determination unit 901 determines the type information of the region. In the present embodiment, the region determination unit 901 determines the type information of the region by denoting the region name that was input by the user from the input/output unit as the type information of the region.

At step S1002, the region characteristics acquisition unit 902 acquires the region variation characteristics based on the type information of the region that has been input. In the present embodiment, the region variation characteristics are acquired by referencing the region variation characteristics table that was read during the initialization processing at step S401.

Here, the region variation characteristics table is a table from which the region variation degree can be referenced based on the type information of the region. In the present embodiment, the ratio of the number of movable objects to the total number of objects that exist in the region at any given time is determined as the region variation degree.

That is, in a case in which more than half of the objects within the region are movable, the region characteristics acquisition unit 902 sets the region variation degree of that region to TRUE, and in a case in which fewer than half of the objects are movable, the region characteristics acquisition unit 902 sets the variation degree to FALSE.

At step S404, the first characteristic acquisition unit 204 acquires the object variation degree as the object variation characteristic based on the object type information.

At step S407, the position and orientation measurement control unit 207 determines the control content of position and orientation measurement based on the object variation degree and region variation degree that have been input. In the present embodiment, the object variation degree and the region variation degree are calculated by logical OR, and the application of the control contents read in step S401 is determined according to the calculation results.

Specifically, the control content is determined such that, in a case in which the calculation result is TRUE, the features within the image region of the target object are not used for position and orientation measurement, and in a case in which the calculation result is FALSE, the features are used.

According to the Second Embodiment explained above, control is performed so as to exclude pixel regions of objects having a large variation degree from captured images, based on the variation characteristics of the target object and the region variation characteristics of the region in which the target object exists. By this control, the control of position and orientation measurement can be improved.

### Modification Example 2-1

In the Second Embodiment, although the region variation degree is determined by the number of movable objects within the region, the region variation degree can be any characteristics that influence the accuracy of position and orientation measurement.

For example, the region variation degree may be the presence or absence of a function to move or rotate objects within the region. Alternatively, rather than by the presence or absence of the function, the region variation degree may be determined by the degree of this function. For example, as in Modification Example 1-2, the position and orientation control content may be determined by threshold processing by using a friction coefficient as a variable, such as the friction coefficient of Expression (1).

Thus, according to the present modification example, by setting the degree of the region variation characteristics, the accuracy of position and orientation measurement can be more reliably improved.

### Modification Example 2-2

In addition, a storage unit (for example, a storage apparatus) may be provided to store the position and orientation information of objects within the region together with a time series, and the region variation degree may be determined from the changes in position and orientation that have been stored in the storage unit.

For example, in a case in which information that an object has moved from within the region to outside the region is stored at two different times, the region variation degree may be set such that the smaller the difference between the two times, the greater the region variation degree becomes. Alternatively, rather than the time difference, the region variation degree may be set such that the greater the distance an object moves between the two different times, the greater the region variation degree becomes.

As explained above, according to the present modification example, by controlling the position and orientation measurement processing based on the actual performance of object variation, the accuracy of the position and orientation measurement can be more reliably improved.

### Modification Example 2-3

The region variation degree may also use the object arrangement characteristics database described in Modification Example 1-7 with respect to objects within the region. For example, based on the object arrangement characteristics database, when a region type name is input, a task database that infers the general object type information vector and the position vector in the region is added. The likelihood of inference results is acquired from the task database, and the region variation degree may be evaluated so that the region variation degree becomes high in regions in which the likelihood is low, and becomes low in regions in which the likelihood is high.

Accordingly, according to the present modification example, the effort required to set the region variation degree can be reduced.

In the Second Embodiment, although the region type information was determined based on input from the user, the system may also make the determination if a unique determination is possible. For example, the region name may be determined based on map information, such as floor plans, and the measurement results of position and orientation measurement units such as SLAM.

Alternatively, feature vectors and position vectors may be input into the object arrangement characteristics database, and the output from the object arrangement characteristics database may then be input into a location prediction database that predicts place labels, thereby determining the region type information. Here, the location prediction database will be explained.

The location prediction database connects a fully connected layer of a one-input one-output neural network to the beginning of the object arrangement characteristics database, and outputs the region name. Accordingly, because it becomes possible to recognize region types by taking into account information of a plurality of objects, rather than merely object recognition, it is possible to recognize the region type with higher accuracy.

### Modification Example 2-4

In the above-described explanation, the position and orientation measurement control unit 207 had uniformly determined the use or non-use, as well as the priority, of the feature group within the pixel region occupied by the target object in the image, in the position and orientation measurement processing. However, the determination may also be made according to the position of the features, taking into account the shape, position, and orientation of the target object or objects within the region.

With respect to the processing content, only the differences from Modification Example 1-4 will be explained. In the present modification example, with respect to objects within the region, a table that can uniquely determine the address to the 3D model data of the objects in the region using the region type information as a key is read during the initialization processing in step S401. At step S407, similar to Modification Example 1-5, the position and orientation measurement control unit 207 determines the use or non-use of features.

Alternatively, the position and orientation measurement control unit 207 may acquire the arrangement information of objects within the region by using the task database described in Modification Example 2-3, which estimates the general objects and the position information thereof upon input of region type information.

Thus, according to the present modification example, by selecting features within the pixel region by using a three-dimensional model, it is possible to exclude only the minimum necessary features, thereby improving the accuracy of position and orientation measurement.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing apparatus and the like through a network or various storage media. Then, a computer (or a CPU, an MPU, or the like) of the information processing apparatus and the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2023-115170, filed on Jul. 13, 2023, which is hereby incorporated by reference herein in its entirety.

What is claimed is:

1. An information processing apparatus configured to perform position and orientation measurement by using sensor data from a sensor, the information processing apparatus comprising at least one processor or circuit configured to function as:
a first characteristic acquisition unit configured to acquire object variation characteristics that indicate characteristics that influence the accuracy of the position and orientation measurement for each object within the measurement range of the sensor;
a proximity object determination unit configured to determine a proximity object that interferes with an object from which the object variation characteristics have been acquired;
a second characteristic acquisition unit configured to acquire object variation factor characteristics that indicate characteristics that influence accuracy of the position and orientation measurement by interfering with other objects with respect to each of the proximity objects; and
a position and orientation measurement control unit configured to control the position and orientation measurement so as to restrict the use of information in which variation is estimated among the information of objects within the measurement range of the sensor, based on the object variation characteristics and the object variation factor characteristics.

2. The information processing apparatus according to claim 1, wherein the object variation characteristics include at least one piece of information that represents the presence or absence of functions that cause movement, rotation, or change of appearance of an object, or the degree of possibility of an object to cause movement, rotation, or change of appearance;
wherein the object variation factor characteristics include at least one piece of information that represents the presence or absence of functions that cause another object to move, rotate, or change appearance, or the degree of possibility of an object to cause another object to move, rotate, or change appearance.

3. The information processing apparatus according to claim 1, wherein the at least one processor or circuit is further configured to function as:
an object variation characteristics evaluation unit configured to evaluate the object variation characteristics;
wherein the object variation characteristics evaluation unit evaluates the object variation characteristics based on an object arrangement characteristics database configured to hold three-dimensional positional relationships of objects in space by associating the object type information and the three-dimensional positional relationships.

4. The information processing apparatus according to claim 1, wherein the at least one processor or circuit is further configured to function as:
an object variation factor characteristics evaluation unit configured to evaluate the object variation factor characteristics;
wherein the object variation factor characteristics evaluation unit evaluates the object variation factor characteristics based on an object arrangement characteristics database configured to hold three-dimensional positional relationships of objects in space by associating the object type information and the three-dimensional positional relationships.

5. An information processing apparatus configured to perform position and orientation measurement by using sensor data from a sensor comprising at least one processor or circuit configured to function as:
a first characteristic acquisition unit configured to acquire object variation characteristics that indicate characteristics that influence the accuracy of the position and orientation measurement for each object within the measurement range of the sensor;
a region determination unit configured to determine the region in which an object that has acquired the object variation characteristics exists;
a region characteristics acquisition unit configured to acquire region variation characteristics that indicate characteristics that influence the accuracy of the position and orientation measurement of the region; and
a position and orientation measurement control unit configured to control the position and orientation measurement so as to restrict the use of information in which variation is estimated among the information of objects within the measurement range of the sensor, based on the object variation characteristics and the region variation characteristics.

6. The information processing apparatus according to claim 5, wherein the region variation characteristics include at least one piece of information that represents the presence or absence of functions that cause movement, rotation, or change of appearance of an object within the region, or the degree of possibility of an object within the region to cause movement, rotation, or change of appearance.

7. The information processing apparatus according to claim 6, wherein the at least one processor or circuit is further configured to function as a region variation characteristics evaluation unit configured to evaluate the region variation characteristics,
wherein the region variation characteristics evaluation unit evaluates the region variation characteristics based on an object arrangement characteristics database configured to hold three-dimensional positional relationships of objects in space by associating the object type information and the three-dimensional positional relationships.

8. A method of controlling an information processing apparatus configured to perform position and orientation measurement by using sensor data from a sensor, the method comprising:
first characteristics acquiring to acquire object variation characteristics that indicate characteristics that influence the accuracy of the position and orientation measurement for each object within the measurement range of the sensor;
proximity object determining to determine a proximity object that interferes with an object from which the object variation characteristics have been acquired;
second characteristics acquiring to acquire object variation factor characteristics that indicate characteristics that influence the accuracy of the position and orientation measurement by interfering with other objects with respect to each of the proximity objects; and
position and orientation measurement controlling to control the position and orientation measurement so as to restrict the use of information in which variation is estimated among the information of objects within the measurement range of the sensor, based on the object variation characteristics and the object variation factor characteristics.

9. A method of controlling an information processing apparatus configured to perform position and orientation measurement by using sensor data from a sensor, the method comprising:
first characteristics acquiring to acquire object variation characteristics that indicate characteristics that influence the accuracy of the position and orientation measurement for each object within the measurement range of the sensor;
region determining to determine the region in which an object that has acquired the object variation characteristics exists;
region characteristics acquiring to acquire region variation characteristics that indicate characteristics that influence the accuracy of the position and orientation measurement of the region; and
position and orientation measurement controlling to control the position and orientation measurement so as to restrict the use of information in which variation is estimated among the information of objects within the measurement range of the sensor, based on the object variation characteristics and the region variation characteristics.

10. A non-transitory computer-readable storage medium configured to store a computer program comprising instructions for executing following processes:
first characteristics acquiring to acquire object variation characteristics that indicate characteristics that influence the accuracy of the position and orientation measurement for each object within the measurement range of the sensor;
proximity object determining to determine a proximity object that interferes with an object from which the object variation characteristics have been acquired;
second characteristics acquiring to acquire object variation factor characteristics that indicate characteristics that influence the accuracy of the position and orientation measurement by interfering with other objects with respect to each of the proximity objects; and
position and orientation measurement controlling to control the position and orientation measurement so as to restrict the use of information in which variation is estimated among the information of objects within the measurement range of the sensor, based on the object variation characteristics and the object variation factor characteristics.
